(19) United States
(12) Patent Application Publication
(10) Pub. No.: US 2026/0046403 A1
(43) Pub. Date: Feb. 12, 2026

(54) FAST H.266/VVC-BASED INTRA CODING UNIT (CU) PARTITIONING METHOD FOR SCREEN CONTENT BASED ON MULTI-TASK LEARNING AND DEVICE

(71) Applicant: Huaqiao University, Quanzhou (CN)

(72) Inventors: Huanqiang ZENG, Quanzhou (CN); Chao JIAO, Quanzhou (CN); Jing CHEN, Quanzhou (CN); Jianqing ZHU, Quanzhou (CN); Rongxin GUO, Quanzhou (CN); Lianchang ZHANG, Xiamen (CN)

(21) Appl. No.: 19/364,883

(22) Filed: Oct. 21, 2025

Related U.S. Application Data
(63) Continuation of application No. PCT/CN2023/137902, filed on Dec. 11, 2023.

(30) Foreign Application Priority Data
Oct. 7, 2023 (CN) 202311280429.6

(51) Int. Cl. H04N 19/119; G06N 20/00; H04N 19/105; H04N 19/147; H04N 19/196

(52) U.S. Cl. CPC H04N 19/119; G06N 20/00; H04N 19/105; H04N 19/147; H04N 19/196

(57) ABSTRACT

An H.266/VVC-based intra coding unit partitioning method for screen content based on multi-task learning and a device, the method includes: partitioning a 128×128 coding tree unit into 64×64 coding units, a multi-task learning network model comprises a trunk network configured to extract CU features, a first sub-network, and a second sub-network, inputting the CU features into the first sub-network and the second sub-network to predict a CU partitioning type and a coding mode, determining the predicted result in combination with the coding mode, a corresponding predicted probability of the coding mode, and a partitioning type of an adjacent CU, inputting the 64×64 CUs into the model to obtain a first predicted result, partitioning each of the 64×64 CUs into four 32×32 CUs in response to determining that the first predicted result is partition, inputting the four 32×32 CUs into the model to obtain a second predicted result.

### RELATED APPLICATIONS

This application is a continuation of International Patent Application PCT/CN2023/137902, filed on Dec. 11, 2023, which claims priority to Chinese Patent Application 202311280429.6, filed on Oct. 7, 2023. International Patent Application PCT/CN2023/137902 and Chinese Patent Application 202311280429.6 are incorporated herein by reference.

### FIELD OF THE DISCLOSURE

The present disclosure relates to the field of video coding, and in particular relates to a fast H.266/VVC-based intra coding unit (CU) partitioning method for screen content based on multi-task learning and a device.

### BACKGROUND OF THE DISCLOSURE

With the rapid development of multimedia communication technologies and video terminal devices, higher requirements are put forward for screen video coding technologies. As H.265/HEVC-SCC can no longer meet compression performance requirements of ultra-high-definition screen videos, the Moving Picture Experts Group (MPEG) and the Video coding Experts Group (VCEG) established Joint Video Exploration Team (JVET) to formulate a new generation video coding standard H.266/VVC, and coding technologies for screen content videos were added to the early version of H.266/VVC.

Compared with H.265/HEVC-SCC, H.266/VVC achieves a higher coding efficiency. Four coding unit (CU) partitioning methods are added in H.266/VVC, including horizontal binary tree, horizontal ternary tree, vertical binary tree, and vertical ternary tree. CUs have 6 choices. The standard encoder needs to execute all of 5,781 probabilities once, record costs of the 6 choices, and finally use a combination that has a minimum cost as a final partitioning result. In addition, H.266/VVC introduces new coding technologies for the screen content videos, such as Intra Block Copy (IBC) and Palette Mode (PLT) coding modes. The IBC and PLT coding modes affect a CU partitioning method simultaneously. A flexible CU partitioning method and a special coding mode in H.266/VVC significantly improve coding performance while increasing huge computational complexity at the same time.

Therefore, how to effectively reduce coding complexity of the screen content while maintaining the coding performance of H.266/VVC has become an urgent problem to be solved in H.266/VVC.

### BRIEF SUMMARY OF THE DISCLOSURE

With respect to the aforementioned technical problem of high H.266/VVC-based intra coding complexity of screen content, the embodiment of the present disclosure provides a fast H.266/VVC-based intra coding unit (CU) partitioning method for the screen content based on multi-task learning and a device to solve the technical problem mentioned in the background. Information of a coding mode is used to assist in deciding a CU partitioning type, so as to effectively reduce a computational complexity of an encoder with almost no impact on coding efficiency.

In a first aspect, the present disclosure discloses a fast H.266/VVC-based intra coding unit (CU) partitioning method for screen content based on multi-task learning, the method comprises the following steps: acquiring a screen content video, coding the screen content video using a standard encoder, directly partitioning a 128×128 coding tree unit (CTU) into 64×64 coding units (CUs), constructing and training a multi-task learning network model to obtain a trained multi-task learning network model, wherein the trained multi-task learning network model comprises a trunk network, a first sub-network, and a second sub-network, the first sub-network and the second sub-network are respectively connected to the trunk network, and the trunk network is configured to extract CU features, inputting the CU features into the first sub-network to predict a CU partitioning type and a corresponding predicted probability of the CU partitioning type, inputting the CU features into the second sub-network to predict a coding mode and a corresponding predicted probability of the coding mode, using the CU partitioning type as a predicted result, or comprehensively determining the predicted result according to the CU partitioning type, the corresponding predicted probability of the CU partitioning type, the coding mode, the corresponding predicted probability of the coding mode, and a partitioning type of an adjacent CU, calling the trained multi-task learning network model during a coding process of the standard coder, inputting the 64×64 CUs into the trained multi-task learning network model to obtain a first predicted result, partitioning the 64×64 CUs according to the first predicted result, wherein partitioning each of the 64×64 CUs into four 32×32 CUs in response to determining that the first predicted result is partition, inputting the four 32×32 CUs into the trained multi-task learning network model to obtain a second predicted result, and partitioning the four 32×32 CUs according to the second predicted result, wherein partitioning each of the 64×64 CUs according to the first predicted result specifically comprises: terminating a rate-distortion optimization search process in response to determining that the CU partitioning type of the first predicted result is non-partition, and partitioning each of the 64×64 CUs into the four 32×32 CUs in response to determining that the CU partitioning type of the first predicted result is the partition, and partitioning each of the 32×32 CUs according to the second predicted result specifically comprises: terminating the rate-distortion optimization search process in response to determining that the CU partitioning type of the second predicted result is non-partition, obtaining four 16×16 CUs in response to determining that the CU partitioning type of the second predicted result is quadtree partition, obtaining two 16×32 CUs in response to determining that the CU partitioning type of the second predicted result is horizontal binary tree partition, obtaining two 32×16 CUs in response to determining that the CU partitioning type of the second predicted result is vertical binary tree partition, obtaining two 8×32 CUs and one 16×32 CU in response to determining that the CU partitioning type of the second predicted result is horizontal ternary tree partition, and obtaining two 32×8 CUs and one 32×16 CU in response to determining that the CU partitioning type of the second predicted result is vertical ternary tree partition.

Preferably, the trunk network comprises a first convolutional layer, a second convolutional layer, a first pooling layer, a third convolutional layer, a fourth convolutional layer, and a second pooling layer connected in sequence, and each of the first convolutional layer, the second convolutional layer, the third convolutional layer, and the fourth convolutional layer has a convolutional kernel size of 3×3, a stride of 1, a padding of 1, and a number of channels is 64, 64, 128, and 128, respectively.

Preferably, the first sub-network comprises a fifth convolutional layer, a sixth convolutional layer, and three first fully connected layers connected in sequence, each of the fifth convolutional layer and the sixth convolutional layer has a kernel size of 1×1, a stride of 1, a padding of 1, and a number of channels is 256 and 256, respectively, and a number of neurons in the three first fully connected layers is 16384, 512, and 2 or 6, respectively, and a dropout ratio is 0.3.

Preferably, the second sub-network comprises a seventh convolutional layer, an eighth convolutional layer, and three second fully connected layers connected in sequence, each of the seventh convolutional layer and the eighth convolutional layer has a kernel size of 1×1, a stride of 1, a padding of 1, and a number of channels is 256 and 256, respectively, and a number of neurons in the three second fully connected layers is 16384, 512, and 4, respectively, and a dropout ratio is 0.25.

Preferably, using the CU partitioning type as the predicted result or comprehensively determining the predicted result according to the CU partitioning type, the corresponding predicted probability of the CU partitioning type, the coding mode, the corresponding predicted probability of the coding mode, and the partitioning type of the adjacent CU specifically comprises: using the CU partitioning type as the predicted result in response to determining that there is no contradiction between the CU partitioning type and the coding mode, and comprehensively determining according to the CU partitioning type, the corresponding predicted probability of the CU partitioning type, the coding mode, the corresponding predicted probability of the coding mode, and the partitioning type of the adjacent CU to determine the predicted result in response to determining that there is a contradiction between the CU partitioning type and the coding mode, wherein comprehensively judging specifically comprises: judging according to the corresponding predicted probability of the coding mode in response to determining that the CU partitioning type is the non-partition and the coding mode is non-allocation mode, judging whether the corresponding predicted probability of the coding mode is greater than a threshold and greater than the corresponding predicted probability of the CU partitioning type, and partitioning both of left and upper CUs of a current CU, selecting a CU partitioning type with a maximum predicted probability as the predicted result when the judgment is yes, otherwise determining the CU partitioning type in the predicted result as the non-partition, and judging whether the corresponding predicted probability of the CU partitioning type is greater than the threshold and greater than the corresponding predicted probability of the coding mode in response to determining that the CU partitioning type is the partition and the coding mode is a mode other than the non-allocation mode, determining the CU partitioning type in the predicted result as the partition when the judgment is yes, otherwise determining the CU partitioning type in the predicted result as the non-partition.

Preferably, a loss function used in a training process of the multi-task learning network model is as follows:

$${Loss}_{w} = - a \frac{{\sum }_{n = 1}^{N} ( \frac{a}{{w}_{1}} ) {q}_{n}^{C U} log ( {p}_{n}^{C U} )}{{\sum }_{n = 1}^{N} ( \frac{a}{{w}_{1}} )} - β \frac{{\sum }_{n = 1}^{N} ( \frac{1}{{w}_{2}} ) {q}_{n}^{M} log ( {p}_{n}^{M} )}{{\sum }_{n = 1}^{N} ( \frac{1}{{w}_{2}} )}$$

α represents a weight of the CU partition of a main task, β represents a weight of the coding mode of an auxiliary task, w₁ represents a proportion of the CU partitioning type q^{cu}, the CU partitioning type q^{cu} corresponds to CUs with different sizes of labels 0 and 1 or 0, 1, 2, 3, 4, and 5, p^{cu} represents the corresponding predicted probability of the CU partitioning type q^{cu}, w₂ represents a proportion of the coding mode q^{M}, the coding mode q^{M} correspond to the CUs with coding mode labels 0, 1, 2, and 3, p^{M} represents the corresponding predicted probability of the coding mode q^{M}, and N represents a number of batches of training samples.

In a second aspect, the present disclosure discloses a fast H.266/VVC-based intra CU partitioning device for screen content based on multi-task learning configured to apply the fast H.266/VVC-based intra CU partitioning method for the screen content based on the multi-task learning, comprising: a coding module, a model construction module, and a prediction module, the coding module is configured to acquire the screen content video, code the screen content video using the standard encoder, and directly partition the 128×128 CTU into the 64×64 CUs, the model construction module is configured to construct and train the multi-task learning network model to obtain the trained multi-task learning network model, the multi-task learning network model comprises the trunk network, the first sub-network, and the second sub-network, the first sub-network and the second sub-network are respectively connected to the trunk network, the trunk network is configured to extract the CU features, the CU features are input into the first sub-network to predict the CU partitioning type and the corresponding predicted probability of the CU partitioning type, the CU features are input into the second sub-network to predict the coding mode and the corresponding predicted probability of the coding mode, the CU partitioning type is used as the predicted result, or the predicted result is comprehensively determined according to the CU partitioning type, the corresponding predicted probability of the CU partitioning type, the coding mode, the corresponding predicted probability of the coding mode, and the partitioning type of the adjacent CU, and the prediction module is configured to call the trained multi-task learning network model during the coding process of the standard encoder, input the 64×64 CUs into the trained multi-task learning network model to obtain the first predicted result, and partition the 64×64 CUs according to the first predicted result, wherein partition each of the 64×64 CUs into the four 32×32 CUs in response to determining that the first predicted result is the partition, input the 32×32 CUs into the trained multi-task learning network model to obtain the second predicted result, and partition the 32×32 CUs according to the second predicted result.

In a third aspect, the present disclosure discloses an electronic device, the electronic device comprises one or more processors and a storage device for storing one or more programs, when the one or more programs are executed by the one or more processors, the fast H.266/VVC-based intra CU partitioning method for the screen content based on the multi-task learning in the first aspect is implemented by the one or more processors.

In a fourth aspect, the present disclosure discloses a non-transitory computer-readable storage medium, a computer program is stored on the non-transitory computer-readable storage medium, and when the computer program is executed by a processor, the fast H.266/VVC-based intra CU partitioning method for the screen content based on the multi-task learning in the first aspect is implemented.

Compared with the existing techniques, the present disclosure has the following advantages.

The fast H.266/VVC-based intra CU partitioning method for the screen content based on the multi-task learning proposed by the present disclosure predicts the CU partition through the multi-task learning network model. A correlation between the coding mode and the CU partition type is found out, and the CU partition type is supervised using the coding mode, which effectively improves a prediction accuracy. Some unnecessary cost calculations can be skipped, and a coding complexity is greatly reduced with almost no impact on a coding efficiency and a video quality.

The multi-task learning network model of the fast H.266/VVC-based intra CU partitioning method for the screen content based on the multi-task learning proposed by the present disclosure extracts the CU features through the trunk network, and the first sub-network and the second sub-network are then used to predict the CU partitioning type and the coding mode respectively. When there is a contradiction between two results of the CU partitioning type and the coding mode, a final CU partitioning type is determined in combination with the predicted probability and the partitioning type of the adjacent CU to ensure an accuracy of the predicted result.

The multi-task learning network model of the fast H.266/VVC-based intra CU partitioning method for the screen content based on the multi-task learning proposed by the present disclosure uses pooling layers and 1×1 convolutions, which have faster calculation time and are convenient for deployment on portable devices.

### BRIEF DESCRIPTION OF THE DRAWINGS

In order to illustrate the technical solutions in the embodiments of the present disclosure more clearly, the drawings required for the description of the embodiments are briefly introduced below. It is obvious that the drawings described below are merely some embodiments of the present disclosure. Other drawings can be obtained based on these drawings without creative works by person of ordinary skill in the art.

FIG. 1 illustrates a view of an exemplary device architecture in which an embodiment of the present disclosure can be applied;

FIG. 2 illustrates a flow chart of a fast H.266/VVC-based intra coding unit (CU) partitioning method for screen content based on multi-task learning of the embodiment of the present disclosure;

FIG. 3 illustrates a structural diagrammatic view of a multi-task learning network model of the fast H.266/VVC-based intra coding unit (CU) partitioning method for the screen content based on the multi-task learning of the embodiment of the present disclosure;

FIG. 4 illustrates a diagrammatic view of a coding process of the fast H.266/VVC-based intra coding unit (CU) partitioning method for the screen content based on the multi-task learning of the embodiment of the present disclosure;

FIG. 5 illustrates a diagrammatic view of a fast H.266/VVC-based intra coding unit (CU) partitioning device for the screen content based on the multi-task learning of the embodiment of the present disclosure; and

FIG. 6 illustrates a structural diagrammatic view of a computer device of an electronic device of suitable for implementing the embodiment of the present disclosure.

### DETAILED DESCRIPTION OF THE EMBODIMENTS

In order to allow an objective, technical solutions, and advantages of the present disclosure to be clearer, the present disclosure will be further described in detail in conjunction with the accompanying drawings. It is obvious that the described embodiments are merely some of the embodiments of the present disclosure instead of all embodiments. All other embodiments fall into the protection scope of the present disclosure provided that they are obtained based on the embodiments of the present disclosure by a person of ordinary skill in the art without creative works.

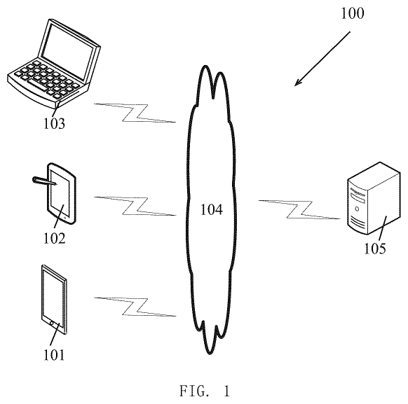

FIG. 1 illustrates an exemplary device architecture 100 in which a fast H.266/VVC-based intra coding unit (CU) partitioning method for screen content based on multi-task learning or a fast H.266/VVC-based intra CU partitioning device for screen content based on the multi-task learning of the embodiment of the present disclosure can be applied.

As shown in FIG. 1, the device architecture 100 can comprise terminal devices 101, 102, and 103, a network 104, and a server 105. The network 104 is used as a medium for providing a communication link between the terminal devices 101, 102, and 103 and the server 105. The network 104 can comprise various connection types, such as wired or wireless communication links, fiber optic cables, etc.

The users can use the terminal devices 101, 102, and 103 to interact with the server 105 through the network 104 to receive or transmit messages, etc. Various applications, such as data processing applications, file processing applications, can be loaded on the terminal devices 101, 102, and 103.

The terminal devices 101, 102, and 103 can be hardware or software. When the terminal devices 101, 102, and 103 are the hardware, the terminal devices 101, 102, and 103 can be various electronic devices, which comprise but are not limited to smartphones, tablet computers, laptop portable computers, desktop computers, etc.

When the terminal devices 101, 102, and 103 are the software, the software can be installed in the electronic devices listed above. The terminal devices 101, 102, and 103 can be implemented as multiple software or multiple software modules (for example, the software or the software modules used to provide distributed services) or as a single software or a single software module. The disclosure is not limited to the aforementioned hardware or software.

The server 105 can be a server that provides various services, such as a background data processing server that processes files or data uploaded by the terminal devices 101, 102, and 103. The background data processing server can process acquired files or data and generate processed results.

It should be noted that the fast H.266/VVC-based intra CU partitioning method for the screen content based on the multi-task learning of the embodiment of the present disclosure can be executed by the server 105 or by the terminal devices 101, 102, and 103. Correspondingly, the fast H.266/VVC-based intra CU partitioning device for the screen content based on the multi-task learning can be installed on the server 105 or the terminal devices 101, 102, and 103.

It should be understood that a number of the terminal devices 101, 102, and 103, the network 104, and the server 105 in FIG. 1 is merely for illustration. There can be any number of the terminal devices 101, 102, and 103, the network 104, and the server 105 according to implementation requirements. In a case where data to be processed does not need to be acquired remotely, the aforementioned device architecture merely needs the server 105 or the terminal devices 101, 102, and 103 without the network 104.

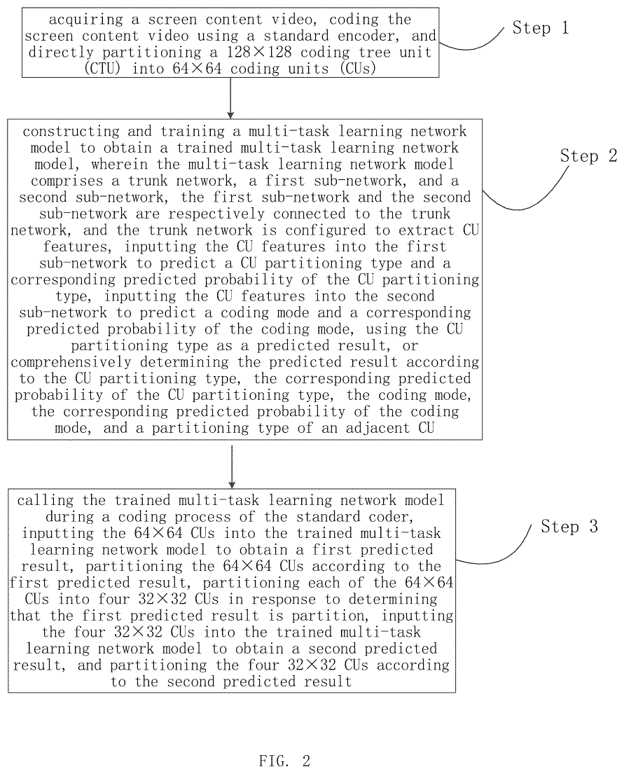

FIG. 2 illustrates the fast H.266/VVC-based intra CU partitioning method for the screen content based on the multi-task learning of the embodiment of the present disclosure, which comprises the following steps:

Step 1 comprises acquiring a screen content video, coding the screen content video using a standard encoder, and directly partitioning a 128×128 coding tree unit (CTU) into 64×64 coding units (CUs).

Specifically, in a coding process of the standard encoder, the 128×128 CTU is first directly partitioned into the 64×64 CUs. Partitioning types of subsequent 64×64 CUs and 32×32 CUs are then predicted using a neural network-based partitioning method, thus significantly reducing coding complexity. A specific neural network structure is described below.

Step 2 comprises constructing and training a multi-task learning network model to obtain a trained multi-task learning network model. The multi-task learning network model comprises a trunk network, a first sub-network, and a second sub-network. The first sub-network and the second sub-network are respectively connected to the trunk network. The trunk network is used to extract CU features. The CU features are input into the first sub-network to predict a CU partitioning type and a corresponding prediction probability of the CU partitioning type. The CU features are input into the second sub-network to predict a coding mode and a corresponding prediction probability of the coding mode. The CU partitioning types is used as a predicted result, or the predicted result is comprehensively determined according to the CU partitioning type, the corresponding predicted probability of the CU partitioning type, the coding mode, the corresponding predicted probability of the coding mode, and a partitioning type of an adjacent CU.

In a specific embodiment, the trunk network comprises a first convolutional layer, a second convolutional layer, a first pooling layer, a third convolutional layer, a fourth convolutional layer, and a second pooling layer connected in sequence. Each of the first convolutional layer, the second convolutional layer, the third convolutional layer, and the fourth convolutional layer has the 3×3 convolutional kernel, the stride is 1, the padding is 1, and the numbers of the channels are 64, 64, 128, and 128, respectively.

In a specific embodiment, the first sub-network comprises a fifth convolutional layer, a sixth convolutional layer, and three first fully connected layers connected in sequence. Each of the fifth convolutional layer and the sixth convolutional layer has the 1×1 convolutional kernel, the stride is 1, the padding is 1, and the numbers of the channels are 256 and 256, respectively. The three first fully connected layers respectively have 16384, 512, and 2 or 6 neurons, and the dropout ratio is 0.3.

In a specific embodiment, the second sub-network comprises a seventh convolutional layer, an eighth convolutional layer, and three second fully connected layers connected in sequence. Each of the seventh convolutional layer and the eighth convolutional layer has a 1×1 convolutional kernel, the stride is 1, the padding is 1, and the numbers of the channels are respectively 256 and 256. The three second fully connected layers have 16384, 512, and 4 neurons, and the dropout ratio is 0.25.

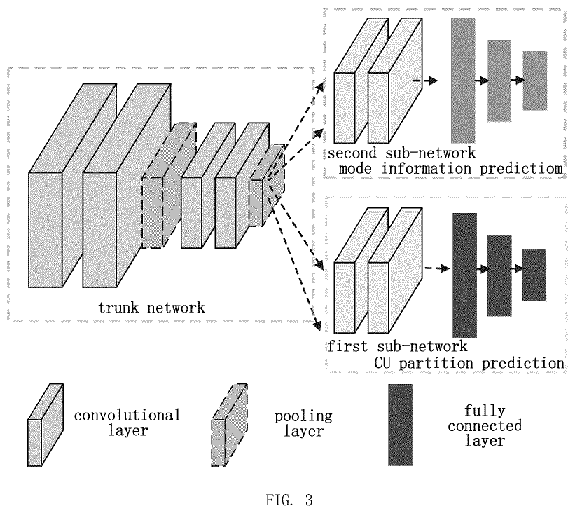

Specifically, referring to FIG. 3, the multi-task learning network model comprises the trunk network and two sub-networks, and the two sub-networks are the first sub-network and the second sub-network, respectively. The first sub-network is used to predict the CU partitioning type and the corresponding predicted probability of the CU partitioning type as a main task, while the second sub-network is used to predict the coding mode and the corresponding prediction probability of the coding mode as an auxiliary task. The coding mode predicted by the auxiliary task can supervise the predicted result of the CU partitioning type to improve an accuracy of the predicted result.

In a specific embodiment, a loss function used in a training process of the multi-task learning network model is as follows:

$${Loss}_{w} = - a \frac{{\sum }_{n = 1}^{N} ( \frac{a}{{w}_{1}} ) {q}_{n}^{C U} log ( {p}_{n}^{C U} )}{{\sum }_{n = 1}^{N} ( \frac{a}{{w}_{1}} )} - β \frac{{\sum }_{n = 1}^{N} ( \frac{1}{{w}_{2}} ) {q}_{n}^{M} log ( {p}_{n}^{M} )}{{\sum }_{n = 1}^{N} ( \frac{1}{{w}_{2}} )}$$

α represents a weight of the CU partition of the main task, β represents a weight of the coding mode of the auxiliary task, w₁ represents a proportion of the CU partitioning type q^{cu}, the CU partitioning type q^{cu} corresponds to CUs with different sizes of labels 0 and 1 or 0, 1, 2, 3, 4, and 5, p^{cu} represents the corresponding predicted probability of the CU partitioning type q^{cu}, w₂ represents a proportion of the coding mode q^{M}, the coding mode q^{M} corresponds to the CUs with coding mode labels 0, 1, 2, and 3, p^{M} represents the corresponding predicted probability of the coding mode q^{M}, and N represents a number of batches of training samples.

Specifically, the training process of the multi-task learning network model is as follows:

(1) Acquiring real labels: collecting the screen content video, coding using the standard encoder, and counting information of the CU partitioning type and information of the coding mode. Different ones of the CU partitioning type and the coding mode are respectively assigned with labels; the 64×64 CUs have two partitioning labels as follows: 0 for non-partition and 1 for quadtree partition, and four labels of the coding mode are as follows: 0 for non-allocation mode, 1 for Intra, 2 for Implicit Behavior Cloning (IBC), and 3 for Personalized Learning Time (PLT). The 32×32 CUs have six partitioning labels as follows: 0 for non-partition, 1 for quadtree partition, 2 for horizontal binary tree partition, 3 for vertical binary tree partition, 4 for horizontal ternary tree partition, and 5 for vertical ternary tree partition, and four labels of the coding mode are as follows: 0 for non-allocation mode, 1 for Intra, 2 for IBC, and 3 for PLT. The 64×64 CUs and the 32×32 CUs are randomly assigned to a training set, a validation set, and a test set at a ratio of 8:1:1.

(2) Considering imbalance a CU partitioning proportion and a mode selecting proportion, a weighted loss function is designed for each of the two sub-networks. The weight α of the CU partition of the main task and the weight β of the coding mode of the auxiliary task vary according to an accuracy variation of the validation set during the training process. In the whole training process, the CU partition of the main task is first trained to near convergence, the coding mode of the auxiliary task is then selectively converged, and finally the CU partition of the main task is converged.

In the training process, the Adam algorithm is selected as an optimization function for a total of 20,000 iterations. An initial learning rate is 0.0001. The learning rate decreases by 10% every 1,000 iterations in 0-10,000 iterations and by 10% every 500 iterations in 10,001-20,000 iterations. Batch sizes in both of the training set and the validation set are 256. When the accuracy of the CU partition reaches approximately 60%, the weight β of the weighted loss function of the auxiliary task is increased. When the accuracy of the auxiliary task reaches approximately 70%, the weight β of the weighted loss function of the auxiliary task is further adjusted, and the weight of the main task is increased simultaneously. In the training process, the learning rate decays by 10% every 1,000 iterations.

In a specific embodiment, the using the CU partitioning type as the predicted result or comprehensively determining the predicted result according to the CU partitioning type, the corresponding predicted probability of the CU partitioning type, the coding mode, the corresponding predicted probability of the coding mode, and the partitioning type of the adjacent CU comprises following steps.

In response to determining that there is no contradiction between the CU partitioning type and the coding mode, the CU partitioning type is directly used as the predicted result.

In response to determining that there is a contradiction between the CU partitioning type and the coding mode, the predicted result is comprehensively determined according to the CU partitioning type, the corresponding predicted probability of the CU partitioning type, the coding mode, the corresponding predicted probability of the coding mode, and the partitioning type of the adjacent CU. The comprehensively determining the predicted result according to the CU partitioning type, the corresponding predicted probability of the CU partitioning type, the coding mode, the corresponding predicted probability of the coding mode, and the partitioning type of the adjacent CU specifically comprises following steps:

In response to determining that the CU partitioning type is non-partition and the coding mode is a non-allocation mode, the predicted result is judged according to the predicted probability of the coding mode. It is determined whether the predicted probability of the coding mode is greater than a threshold and greater than the predicted probability corresponding to the CU partitioning type, and both of left and upper CUs of the current CU are partitioned. If so, selecting the CU partitioning type with a highest predicted probability as the predicted result; otherwise, the CU partitioning type in the predicted result is the non-partition.

In response to determining that the CU partitioning type is partition and the coding mode is other than the non-allocation mode, it is determined whether the predicted probability of the CU partitioning type is greater than the threshold and greater than the predicted probability corresponding to the coding mode. If so, the CU partitioning type in the predicted result is the partition; otherwise, the CU partitioning type in the predicted result is the non-partition.

Specifically, in normal conditions in which the CU partitioning type is the partition and the corresponding coding mode is the non-allocation mode, and the CU partitioning type is the non-partition and the corresponding coding modes are three modes: Intra, IBC, or PLT. When the coding mode and the CU partitioning type contradict, joint judgment is required by combining the predicted probability and the partitioning type of the adjacent CU. In an embodiment, the threshold is set to 0.8. A first contradiction is as follows: when the CU partitioning type predicted by the first sub-network is the non-partition while the coding mode predicted by the second sub-network is the non-allocation mode, this situation contradicts an actual coding situation. At this time, judgment is required based on the predicted probability P_{mode} corresponding to the coding mode. When the P_{mode} is larger than 0.8 and larger than the predicted probability Pₛₚₗᵢₜ corresponding to the CU partitioning type and the left and upper CUs of the current CU are partitioned, the predicted result that the CU is the non-partition is invalid, and the CU partitioning type with a highest predicted probability is selected as the predicted result. A second contradiction is as follows: when the CU partitioning type predicted by the first sub-network is the partition while the coding mode predicted by the second sub-network is one of Intra, IBC, or PLT, this situation contradicts the actual coding situation. In this case, the predicted probability Pₛₚₗᵢₜ corresponding to the CU partitioning type is required to be larger than 0.8 and larger than the predicted probability P_{mode} corresponding to the coding mode, and the CU partitioning type of the predicted result is judged to be the partition.

Step 3 comprises, during the coding process of the standard encoder, calling the trained multi-task learning network model, inputting the 64×64 CUs into the trained multi-task learning network model to obtain a first predicted result, and partitioning the 64×64 CUs according to the first predicted result. In response to determining that the first predicted result is the partition, partitioning each of the 64×64s CU into four 32×32 CUs, inputting the four 32×32 CUs into the trained multi-task learning network model to obtain a second predicted result, and partitioning each of the four 32×32 CUs according to the second predicted result.

In a specific embodiment, the partitioning the 64×64 CUs according to the first predicted result specifically comprises:

Terminating a rate-distortion optimization search process in response to determining that the CU partitioning type of the first predicted result is the non-partition.

Partitioning each of the 64×64 CUs into the four 32×32 CUs in response to determining that the CU partitioning type of the first predicted result is the partition.

The partitioning each of the four 32×32 CUs according to the second predicted result specifically comprises:

Terminating a rate-distortion optimization search process in response to determining that the CU partitioning type of the second predicted result is the non-partition.

Obtaining four 16×16 CUs in response to determining that the CU partitioning type of the second predicted result is the quadtree partition.

Obtaining two 16×32 CUs in response to determining that the CU partitioning type of the second predicted result is the horizontal binary tree partition.

Obtaining two 32×16 CUs in response to determining that the CU partitioning type of the second predicted result is the vertical binary tree partition.

Obtaining two 8×32 CUs and one 16×32 CUs in response to determining that the CU partitioning type of the second predicted result is the horizontal ternary tree partition.

Obtaining two 32×8 CUs and one 32×16 CUs in response to determining that the CU partitioning type of the second predicted result is the vertical ternary tree partition.

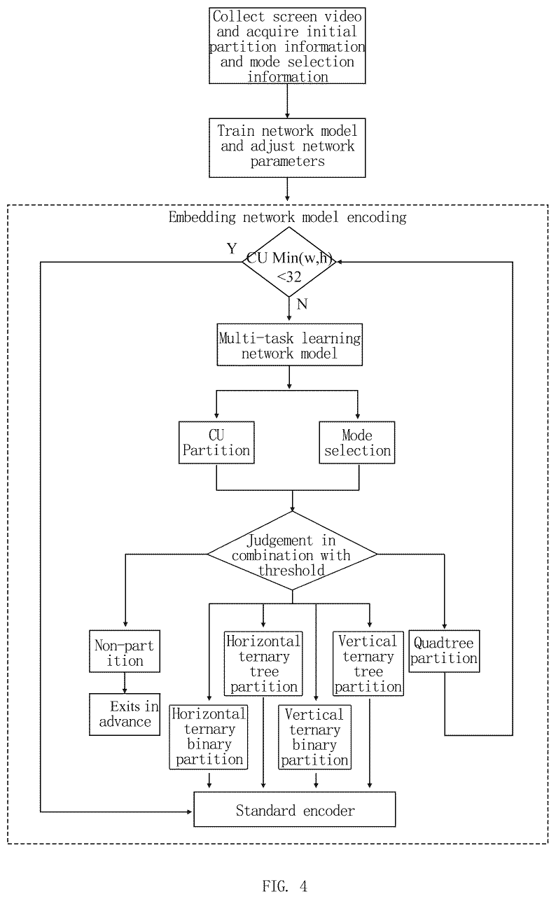

Specifically, referring to FIG. 4, during the coding process, the trained multi-task learning network model is called, and the 64×64 CUs are input into the trained multi-task learning network model to obtain the predicted probabilities of the CU partitioning type and the coding mode. The first predicted result is obtained by integrating the predicted probabilities and the partitioning method of the adjacent CU, and the 64×64 CUs are partitioned according to the CU partitioning type in the first predicted result. Specifically, if the CU partitioning type of the first predicted result is the non-partition, the rate-distortion optimization search process is terminated. If the CU partitioning type of the first predicted result is the partition, each of the 64×64 CUs is partitioned into the four 32×32 CUs.

Further, the coding process exits in response to determining that the first predicted result is the non-partition. Each of the 64×64 CUs is partitioned into the four 32×32 CUs in response to determining that the first predicted result is the partition, and the four 32×32 CUs are input into the trained multi-task learning network model to be predicted. The second predicted result is obtained by integrating the prediction probabilities and the partitioning method of the adjacent CU, and each of the four 32×32 CUs is partitioned according to the CU partitioning type in the second predicted result. Specifically, if the CU partitioning type of the second predicted result is the non-partition, the rate-distortion optimization search process is terminated. If the CU partitioning type of the second predicted result is the quadtree partition, the four 16×16 CUs are obtained. If the CU partitioning type of the second predicted result is the horizontal binary tree partition, the two 16×32 CUs are obtained. If the CU partitioning type of the second predicted result is the vertical binary tree partition, the two 32×16 CUs are obtained. If the CU partitioning type of the second predicted result is the horizontal ternary tree partition, the two 8×32 CUs and the one 16×32 CU are obtained. If the CU partitioning type of the second predicted result is vertical ternary tree partition, the two 32×8 CUs and the one 32×16 CU are obtained.

The present disclosure predicts the two partitioning methods of the 64×64 CUs based on the multi-task learning network model. Unnecessary cost calculations are skipped to significantly reduce coding complexity of the screen content in VVC without impact on coding efficiency.

The steps 1-3 are identifiers rather than merely representing a sequence between the steps 1-3.

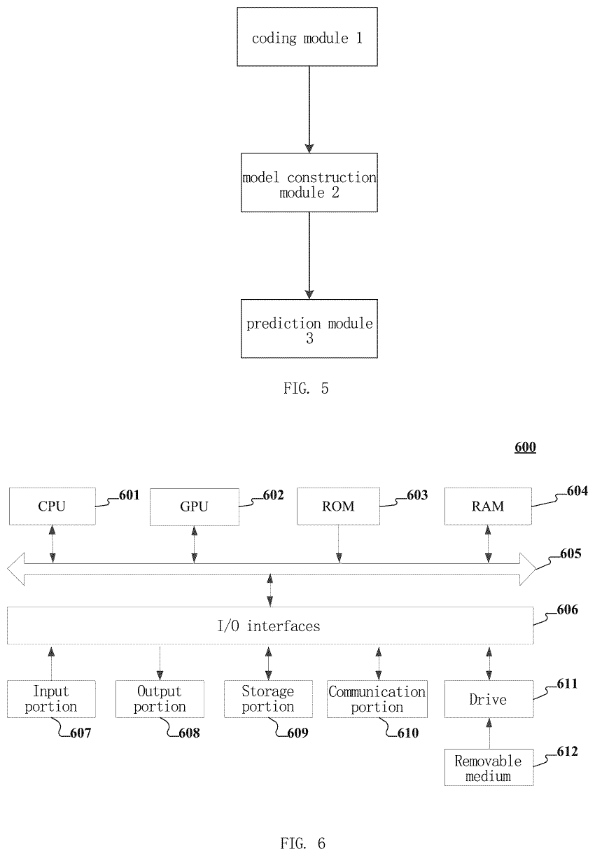

Further, referring to FIG. 5, as an implementation of the methods described in the drawings, the present disclosure provides an embodiment of a fast H.266/VVC-based intra coding unit (CU) partitioning device for the screen content based on the multi-task learning. This device in the embodiment corresponds to the method in the embodiment described in FIG. 2 and can be specifically applied to various electronic devices.

The embodiment of the present disclosure provides the fast H.266/VVC-based intra CU partitioning device for the screen content based on the multi-task learning that applies the fast H.266/VVC-based intra CU partitioning method for the screen content based on the multi-task learning and comprises:

A coding module 1 configured to acquire the screen content video, code the screen content video using the standard encoder, and directly partition the 128×128 CTU into the 64×64 CUs.

A model construction module 2 configured to construct and train the multi-task learning network model to obtain the trained multi-task learning network model. The trained multi-task learning network model comprises the trunk network, the first sub-network, and the second sub-network. The first sub-network and the second sub-network are respectively connected to the trunk network. The trunk network is used to extract the CU features. The CU features are input into the first sub-network to predict the CU partitioning type and the corresponding predicted probability of the CU partitioning type. The CU features are input into the second sub-network to predict the coding mode and a corresponding predicted probability of the coding mode. The CU partitioning type is used as the predicted result, or the predicted result is comprehensively determined based on the CU partitioning type, the predicted probability of the CU partitioning type, the coding mode, the predicted probability of the coding mode, and the partitioning type of the adjacent CU.

A prediction module 3 configured to call the trained multi-task learning network model during the coding process of the standard encoder. The 64×64 CUs are input into the trained multi-task learning network model to obtain the first predicted result, and each of the 64×64 CUs is partitioned according to the first predicted result. Each of the 64×64 CUs is partitioned into the four 32×32 CUs in response to determining that the first predicted result is the partition, each of the four 32×32 CUs is input into the trained multi-task learning network model to obtain the second predicted result, and the four 32×32 CUs are partitioned according to the second predicted result.

FIG. 6 illustrates a structural diagrammatic view of a computer device 600 of the electronic device (e.g., the server or the terminal device in FIG. 1) suitable for implementing of the embodiment of the present disclosure. The electronic device shown in FIG. 6 is merely an example and should not impose any limitations on the functionality and the application scope of the embodiment of the present disclosure.

As shown in FIG. 6, the computer device 600 comprises a central processing unit (CPU) 601 and a graphics processing unit (GPU) 602. The CPU 601 and the GPU 602 can execute various appropriate actions and processes according to programs stored in a read-only memory (ROM) 603 or programs loaded into a random access memory (RAM) 604 from a storage portion 609. The RAM 604 also stores various programs and data required for an operation of the computer device 600. The CPU 601, the GPU 602, the ROM 603, and the RAM 604 are connected to each other via a bus 605. Input/output (I/O) interfaces 606 are also connected to the bus 605.

The following components are connected to the I/O interfaces 606. The following components comprise an input portion 607 such as a keyboard or mouse, an output portion 608 such as a liquid crystal display (LCD) or speaker, the storage portion 609 such as a hard disk, and a communication portion 610 of a network interface card such as a local area network (LAN) card or a modem. Communication processing of the communication portion 610 is executed via a network such as the Internet. A drive 611 can also be connected to the I/O interfaces 606 as needed. A removable medium 612, such as a magnetic disk, an optical disk, a magneto-optical disk, or a semiconductor memory, is installed on the drive 611 as needed and installs a computer program read from the removable medium 612 into the storage portion 609 as needed.

In particular, according to the embodiment of the present disclosure, the processes described with reference to the flowchart in the preceding description can be implemented as a computer software program. For example, the embodiment of the present disclosure comprises a computer program product, and the computer program product comprises a computer program embodied on a computer-readable medium. The computer program comprises program codes for executing the method shown in the flowchart. In this embodiment, the computer program can be downloaded and at least one of installed from the network via the communication portion 610 or installed from the removable medium 612. When the computer program is executed by the CPU 601 and the GPU 602, the computer program executes the functions defined in the method of the present disclosure.

It should be noted that the computer-readable medium described in the present disclosure can be a computer-readable signal medium, a computer-readable medium, or any combination of the computer-readable signal medium and the computer-readable medium. The computer-readable medium can be, for example, at least one of electrical, magnetic, optical, electromagnetic, infrared, or semiconductor devices, apparatus, or components, but the disclosure is not limited thereto. More specific examples of the computer-readable medium comprise at least one of an electrical connection with one or more wires, a portable computer disk, a hard disk, the RAM 604, the ROM 603, an erasable programmable read-only memory (EPROM) (i.e., Flash memory), an optical fiber, a portable compact disc read-only memory (CD-ROM), an optical storage device, or a magnetic storage device, but the disclosure is not limited thereto. In the present disclosure, the computer-readable medium can be any tangible medium that contains or stores a program, and the program can be used by or in conjunction with an instruction execution device, an apparatus, or an equipment. The computer-readable signal medium can comprise a data signal propagated in a baseband or as part of a carrier wave, and computer-readable program codes are embodied on the computer-readable signal medium. The propagated data signal can use various forms of at least one of an electromagnetic signal or an optical signal, but the disclosure is not limited thereto. The computer-readable signal medium can also be any computer-readable medium other than the aforementioned computer-readable medium, and the any computer-readable medium can transmit, propagate, or transmit the program that can be used by at least one of the instruction execution device, the apparatus, or the equipment. Program codes contained on the computer-readable medium can be transmitted by any suitable medium such as at least one of wireless, wire, optical fiber cable, or Radio Frequency (RF), but the disclosure is not limited thereto.

The computer program codes for performing the operation of the present disclosure can be coded by one or more programming languages, and the one or more programming languages comprise object-oriented programming languages such as Java, Smalltalk, C++, and conventional procedural programming languages such as the “C” language or similar programming languages. The computer program codes can be executed entirely on a computer of a user, executed partly on the computer of the user, executed as an independent software package, executed partly on the computer of the user and partly on a remote computer, or executed entirely on the remote computer or the server. In cases involving the remote computer, the remote computer can be connected to the computer of the user through any type of network, including the LAN or a wide area network (WAN) or can be connected to an external computer (e.g., through the Internet by an Internet service provider).

The flowcharts and the block diagrams in the accompanying drawings illustrate architectures, functionalities, and operation of possible implementations of devices, methods, and computer program products according to various embodiments of the present disclosure. In this aspect, a block in the flowcharts or the block diagrams can represent a module, program segment, or a portion of the codes. The module, the program segment, or the portion of the codes contains one or more executable instructions for implementing a specified logical function. It should also be noted that, in some alternative implementations, the specified logical function noted in the block can occur in a sequence differing from the sequence specified in the drawings. For example, two blocks shown in sequence can be factually executed substantially in parallel or can sometimes be executed in a reverse order, which depends upon the functionalities involved. It should also be noted that at least one block of the block diagrams or the flowcharts can be implemented by a specified hardware-based device that executes specified functions or operations or can be implemented by a combination of the specified hardware-based device and a computer instruction.

The modules described in the embodiments of the present disclosure can be implemented by software or hardware. The described modules can also be disposed in a processor.

In another aspect, the present disclosure also provides a computer-readable medium, and the computer-readable medium can be included in the electronic device described in the embodiments or can exist separately without being assembled into the electronic device. The computer-readable medium embodies one or more programs.

When the one or more programs are executed by the electronic device, the electronic device is enabled to: acquire the screen content video, code the screen content video using the standard encoder, directly partition the 128×128 coding tree unit (CTU) into the 64×64 coding units (CUs), and construct and train the multi-task learning network model to obtain the trained multi-task learning network model. The trained multi-task learning network model comprises the trunk network, the first sub-network, and the second sub-network, and the first sub-network and the second sub-network are respectively connected to the trunk network. The trunk network is configured to extract CU features, input the CU features into the first sub-network to predict the CU partitioning type and the corresponding predicted probability of the CU partitioning type, input the CU features into the second sub-network to predict the coding mode and the corresponding predicted probability of the coding mode, and use the CU partitioning type as the predicted result or comprehensively determine the predicted result according to the CU partitioning type, the corresponding predicted probability of the CU partitioning type, the coding mode, the corresponding predicted probability of the coding mode, and the partitioning type of the adjacent CU. The electronic device is also enabled to: call the trained multi-task learning network model during the coding process of the standard encoder, input the 64×64 CUs into the trained multi-task learning network model to obtain the first predicted result, and partition each of the 64×64 CUs according to the first predicted result, wherein each of the 64×64 CUs is partitioned into four 32×32 CUs in response to determining that the first predicted result is the partition. The electronic device is also enabled to: input the 32×32 CUs into the trained multi-task learning network model to obtain the second predicted result, and partition each of the 32×32 CUs according to the second predicted result.

The aforementioned description is merely used to illustrate preferred embodiments of this present disclosure and the applied technical principles. It should be understood by those of skill in the art that the scope involved in the present disclosure is not limited to the technical solutions combined by the specific combinations of the technical features and also covers other technical solutions formed by any combination of the technical features or their equivalent features without departing from the concept of the present disclosure. For example, the disclosure also covers technical solutions formed by replacing the features disclosed herewith with features with functions similar to those disclosed in the present disclosure.

1. A fast H.266/VVC-based intra coding unit (CU) partitioning method for screen content based on multi-task learning, comprising:
acquiring a screen content video, coding the screen content video using a standard encoder, and directly partitioning a 128×128 coding tree unit (CTU) into 64×64 coding units (CUs),
constructing and training a multi-task learning network model to obtain a trained multi-task learning network model, wherein:
the multi-task learning network model comprises a trunk network, a first sub-network, and a second sub-network,
the first sub-network and the second sub-network are respectively connected to the trunk network, and
the trunk network is configured to extract CU features,
inputting the CU features into the first sub-network to predict a CU partitioning type and its corresponding predicted probability,
inputting the CU features into the second sub-network to predict a coding mode and its corresponding predicted probability,
using the CU partitioning type as a predicted result, or comprehensively determining the predicted result according to the CU partitioning type and its corresponding predicted probability, the coding mode and its corresponding predicted probability, and a partitioning type of an adjacent CU,
calling the trained multi-task learning network model during a coding process of the standard coder,
inputting the 64×64 CUs into the trained multi-task learning network model to obtain a first predicted result,
performing CU partition according to the first predicted result, and partitioning a 64×64 CU into four 32×32 CUs in response to determining that the first predicted result is partition, inputting the four 32×32 CUs into the trained multi-task learning network model to obtain a second predicted result, and performing CU partition according to the second predicted result, wherein:
performing the CU partition according to the first predicted result specifically comprises:
terminating a rate-distortion optimization search process in response to determining that the CU partitioning type of the first predicted result is non-partition, and
partitioning the 64×64 CU into the four 32×32 CUs in response to determining that the CU partitioning type of the first predicted result is the partition, and
performing the partition according to the second predicted result specifically comprises:
terminating the rate-distortion optimization search process in response to determining that the CU partitioning type of the second predicted result is non-partition,
obtaining four 16×16 CUs in response to determining that the CU partitioning type of the second predicted result is quadtree partition,
obtaining two 16×32 CUs in response to determining that the CU partitioning type of the second predicted result is horizontal binary tree partition,
obtaining two 32×16 CUs in response to determining that the CU partitioning type of the second predicted result is vertical binary tree partition,
obtaining two 8×32 CUs and one 16×32 CU in response to determining that the CU partitioning type of the second predicted result is horizontal ternary tree partition, and
obtaining two 32×8 CUs and one 32×16 CU in response to determining that the CU partitioning type of the second predicted result is vertical ternary tree partition.

2. The fast H.266/VVC-based intra CU partitioning method for the screen content based on the multi-task learning according to claim 1, wherein:
the trunk network comprises a first convolutional layer, a second convolutional layer, a first pooling layer, a third convolutional layer, a fourth convolutional layer, and a second pooling layer connected in sequence, and
each of the first convolutional layer, the second convolutional layer, the third convolutional layer, and the fourth convolutional layer has a convolutional kernel size of 3×3, a stride of 1, a padding of 1, and a number of channels is 64, 64, 128, and 128, respectively.

3. The fast H.266/VVC-based intra CU partitioning method for the screen content based on the multi-task learning according to claim 1, wherein:
the first sub-network comprises a fifth convolutional layer, a sixth convolutional layer, and three first fully connected layers connected in sequence,
each of the fifth convolutional layer and the sixth convolutional layer has a kernel size of 1×1, a stride of 1, a padding of 1, and a number of channels is 256 and 256, respectively, and
a number of neurons in the three first fully connected layers is 16384, 512, and 2 or 6, respectively, and a dropout ratio is 0.3.

4. The fast H.266/VVC-based intra CU partitioning method for the screen content based on the multi-task learning according to claim 1, wherein:
the second sub-network comprises a seventh convolutional layer, an eighth convolutional layer, and three second fully connected layers connected in sequence,
each of the seventh convolutional layer and the eighth convolutional layer has a kernel size of 1×1, a stride of 1, a padding of 1, and a number of channels is 256 and 256, respectively, and
a number of neurons in the three second fully connected layers is 16384, 512, and 4, respectively, and a dropout ratio is 0.25.

5. The fast H.266/VVC-based intra CU partitioning method for the screen content based on the multi-task learning according to claim 1, wherein:
using the CU partitioning type as the predicted result or comprehensively determining the predicted result according to the CU partitioning type, the corresponding predicted probability of the CU partitioning type, the coding mode, the corresponding predicted probability of the coding mode, and the partitioning type of the adjacent CU specifically comprises:
using the CU partitioning type as the predicted result in response to determining that there is no contradiction between the CU partitioning type and the coding mode, and
comprehensively determining according to the CU partitioning type, the corresponding predicted probability of the CU partitioning type, the coding mode, the corresponding predicted probability of the coding mode, and the partitioning type of the adjacent CU to determine the predicted result in response to determining that there is a contradiction between the CU partitioning type and the coding mode, wherein comprehensively judging specifically comprises:
judging according to the corresponding predicted probability of the coding mode in response to determining that the CU partitioning type is the non-partition and the coding mode is non-allocation mode, judging whether the corresponding predicted probability of the coding mode is greater than a threshold and greater than the corresponding predicted probability of the CU partitioning type, and partitioning both of left and upper CUs of a current CU, selecting a CU partitioning type with a maximum predicted probability as the predicted result when the judgment is yes, otherwise determining the CU partitioning type in the predicted result as the non-partition, and
judging whether the corresponding predicted probability of the CU partitioning type is greater than the threshold and greater than the corresponding predicted probability of the coding mode in response to determining that the CU partitioning type is the partition and the coding mode is a mode other than the non-allocation mode, determining the CU partitioning type in the predicted result as the partition when the judgment is yes, otherwise determining the CU partitioning type in the predicted result as the non-partition.

6. The fast H.266/VVC-based intra CU partitioning method for the screen content based on the multi-task learning according to claim 1, wherein:
a loss function used in a training process of the multi-task learning network model is as follows:
$${Loss}_{w} = - a \frac{{\sum }_{n = 1}^{N} ( \frac{a}{{w}_{1}} ) {q}_{n}^{C U} log ( {p}_{n}^{C U} )}{{\sum }_{n = 1}^{N} ( \frac{a}{{w}_{1}} )} - β \frac{{\sum }_{n = 1}^{N} ( \frac{1}{{w}_{2}} ) {q}_{n}^{M} log ( {p}_{n}^{M} )}{{\sum }_{n = 1}^{N} ( \frac{1}{{w}_{2}} )}$$
□□ represents a weight of the CU partition of a main task, □ represents a weight of the coding mode of an auxiliary task, w₁ represents a proportion of the CU partitioning type q^{cu}, the CU partitioning type q^{cu} corresponds to CUs with different sizes of labels 0 and 1 or 0, 1, 2, 3, 4, and 5, p^{cu} represents the corresponding predicted probability of the CU partitioning type q^{cu}, w₂ represents a proportion of the coding mode q^{M}, the coding mode q^{M} correspond to the CUs with coding mode labels 0, 1, 2, and 3, p^{M} represents the corresponding predicted probability of the coding mode q^{M}, and N represents a number of batches of training samples.

7. A fast H.266/VVC-based intra CU partitioning device for screen content based on multi-task learning applied the fast H.266/VVC-based intra CU partitioning method for the screen content based on the multi-task learning according to claim 1, comprising:
a coding module,
a model construction module, and
a prediction module, wherein:
the coding module is configured to acquire the screen content video, code the screen content video using the standard encoder, and directly partition the 128×128 CTU into the 64×64 CUs,
the model construction module is configured to construct and train the multi-task learning network model to obtain the trained multi-task learning network model, the multi-task learning network model comprises the trunk network, the first sub-network, and the second sub-network, the first sub-network and the second sub-network are respectively connected to the trunk network, the trunk network is configured to extract the CU features, the CU features are input into the first sub-network to predict the CU partitioning type and the corresponding predicted probability of the CU partitioning type, the CU features are input into the second sub-network to predict the coding mode and the corresponding predicted probability of the coding mode, the CU partitioning type is used as the predicted result, or the predicted result is comprehensively determined according to the CU partitioning type, the corresponding predicted probability of the CU partitioning type, the coding mode, the corresponding predicted probability of the coding mode, and the partitioning type of the adjacent CU, and
the prediction module is configured to call the trained multi-task learning network model during the coding process of the standard encoder, input the 64×64 CUs into the trained multi-task learning network model to obtain the first predicted result, and partition the 64×64 CUs according to the first predicted result, wherein partition each of the 64×64 CUs into the four 32×32 CUs in response to determining that the first predicted result is the partition, input the 32×32 CUs into the trained multi-task learning network model to obtain the second predicted result, and partition the 32×32 CUs according to the second predicted result.

8. An electronic device, comprising:
one or more processors, and
a storage device for storing one or more programs, wherein:
when the one or more programs are executed by the one or more processors, the fast H.266/VVC-based intra CU partitioning method for the screen content based on the multi-task learning according to claim 1 is implemented by the one or more processors.

9. A non-transitory computer-readable storage medium, wherein:
a computer program is stored on the non-transitory computer-readable storage medium, and
when the computer program is executed by a processor, the fast H.266/VVC-based intra CU partitioning method for the screen content based on the multi-task learning according to claim 1 is implemented.
